(19) United States
(12) Patent Application Publication
(10) Pub. No.: US 2026/0079717 A1
(43) Pub. Date: Mar. 19, 2026

(54) NON-TRANSITORY COMPUTER-READABLE RECORDING MEDIUM, CONTROL METHOD, AND CONTROL DEVICE

(71) Applicant: Fujitsu Limited, Kawasaki-shi (JP)

(72) Inventors: Hitoshi MATSUMORI, Kawasaki (JP); Kazushige KOBAYAKAWA, Numazu (JP)

(73) Assignee: Fujitsu Limited, Kawasaki-shi (JP)

(21) Appl. No.: 19/332,304

(22) Filed: Sep. 18, 2025

(30) Foreign Application Priority Data
Sep. 19, 2024 (JP) 2024-161570

(51) Int. Cl. G06F 9/4401

(52) U.S. Cl. CPC G06F 9/4403

(57) ABSTRACT

A control device includes a reset state continuation unit and a reset state release unit. The reset state continuation unit that, continues a state of the reset of the controller, in response to detection of an operation of the reset by the controller for the controller itself, the controller performing a process of controlling hardware by executing firmware stored in a first memory. The reset state release unit that releases the state of the reset in response to detection of completion of an operation of writing an updated version of the firmware into the first memory by a management unit that manages the firmware.

### CROSS-REFERENCE TO RELATED APPLICATION

This application is based upon and claims the benefit of priority of the prior Japanese Patent Application No. 2024-161570, filed on Sep. 19, 2024, the entire contents of which are incorporated herein by reference.

### FIELD

The embodiments discussed herein are related to technologies for reset control.

### BACKGROUND

Technologies to avoid a boot failure from platform firmware recovery execution are known (for example, refer to Japanese Laid-open Patent Publication No. 2023-66353).

A baseboard management controller (BMC) is widely known as a device that controls the hardware of computer devices. The BMC performs this control by executing software, referred to as firmware or the like. The firmware is stored in a memory in the computer device, and the integrity of this firmware is sometimes checked using a dedicated device referred to as a platform firmware resilience (PFR). Contention may occur between the PFR and the BMC over access to the memory that stores the firmware. For example, memory access contention occurs when the BMC detecting its own operation abnormality reboots itself while the PFR is accessing the memory to check the integrity of the firmware. Such access contention may cause a failure in operation of the computer device.

### SUMMARY

According to an aspect of an embodiment, a control device includes a reset state continuation unit and a reset state release unit. The reset state continuation unit that, continues a state of the reset of the controller, in response to detection of an operation of the reset by the controller for the controller itself, the controller performing a process of controlling hardware by executing firmware stored in a first memory. The reset state release unit that releases the state of the reset in response to detection of completion of an operation of writing an updated version of the firmware into the first memory by a management unit that manages the firmware.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first example of a configuration of a computer system;

FIG. 2 is a timing chart illustrating a first example of the operation timing of each component of the computer system;

FIG. 3 is a sequence diagram illustrating a flow of a first example of firmware update operation;

FIG. 4 is a timing chart illustrating a second example of the operation timing of each component of the computer system;

FIG. 5 is a sequence diagram illustrating a flow of a second example of firmware update operation;

FIG. 6 is a timing chart illustrating a third example of the operation timing of each component of the computer system;

FIG. 7 is a diagram illustrating a second example of a configuration of the computer system;

FIG. 8 is a diagram illustrating an example of a functional configuration of a PLD;

FIG. 9 is a sequence diagram illustrating a flow of a third example of firmware update operation;

FIG. 10 is a timing chart illustrating a fourth example of the operation timing of each component of the computer system; and

FIG. 11 is a diagram illustrating a hardware configuration example of a processor.

### DESCRIPTION OF EMBODIMENTS

Preferred embodiments of the present invention will be explained with reference to accompanying drawings.

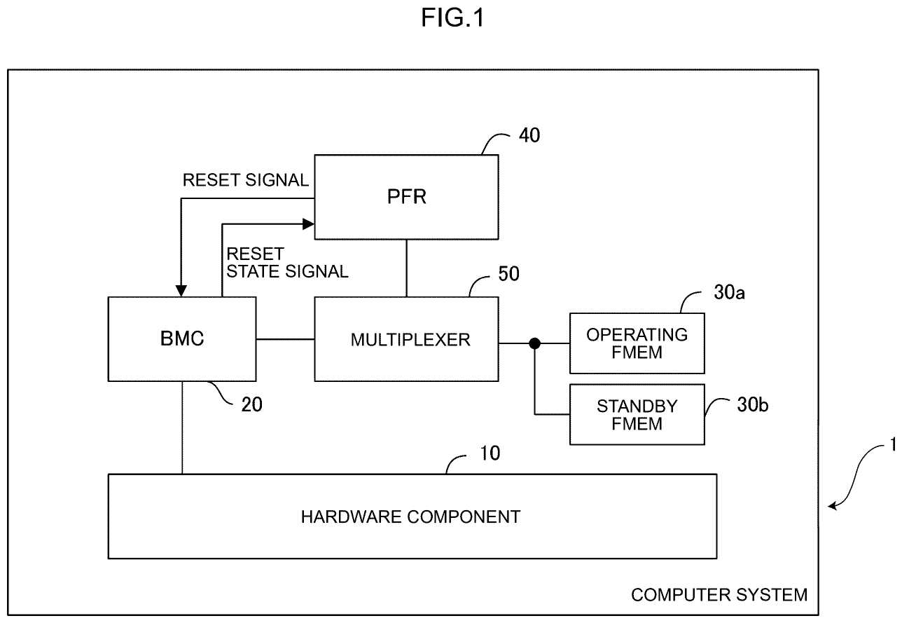

FIG. 1 illustrates a first example of a configuration of a computer system 1.

The computer system 1 of the first example includes a hardware component 10, a BMC 20, an operating FMEM 30a, a standby FMEM 30b, a PFR 40, and a multiplexer 50. “FMEM”is an abbreviation for flash memory.

The hardware component 10 is various hardware such as a CPU, a memory, a hard disk, and a communication I/F, which are components of the computer system 1. “CPU” is an abbreviation for central processing unit, and “I/F” is an abbreviation for interface.

The BMC 20 is a device that manages the hardware component 10 and is an example of a controller that performs a process of controlling the hardware component 10 by executing firmware.

Both the operating FMEM 30a and the standby FMEM 30b are memories that store firmware. The BMC 20 performs a process of controlling the hardware component 10 by reading and executing the firmware stored in the operating FMEM 30a. The standby FMEM 30b is a memory that stores a backup of the firmware stored in the operating FMEM 30a. The operating FMEM 30a and the standby FMEM 30b are examples of first and second memories, respectively.

The PFR 40 is an example of a management unit that manages the firmware stored in each of the operating FMEM 30a and the standby FMEM 30b, and is a device that checks the integrity of the firmware. Details of the operation of the PFR 40 will be described later.

The multiplexer 50 is a circuit that selects one of the BMC 20 and the PFR 40 to connect to the operating FMEM 30a and the standby FMEM 30b. The multiplexer 50 may have a function of a serial peripheral interface (SPI) if appropriate.

A reset signal is a signal driven by the PFR 40 to maintain a reset state of the BMC 20. In the present embodiment, the reset signal is a signal with two different signal levels, that is, a signal with a signal level of either high level or low level, and the BMC 20 maintains its own reset state while the reset signal received from the PFR 40 is at high level.

A reset state signal is a signal driven by the BMC 20 and indicates whether an operating state of the BMC 20 is the reset state. In the present embodiment, the reset state signal is a signal with a signal level of either high level or low level, and the reset state signal with a signal level of high level indicates that an operating state of the BMC 20 is the reset state.

The operation of the PFR 40 will now be described.

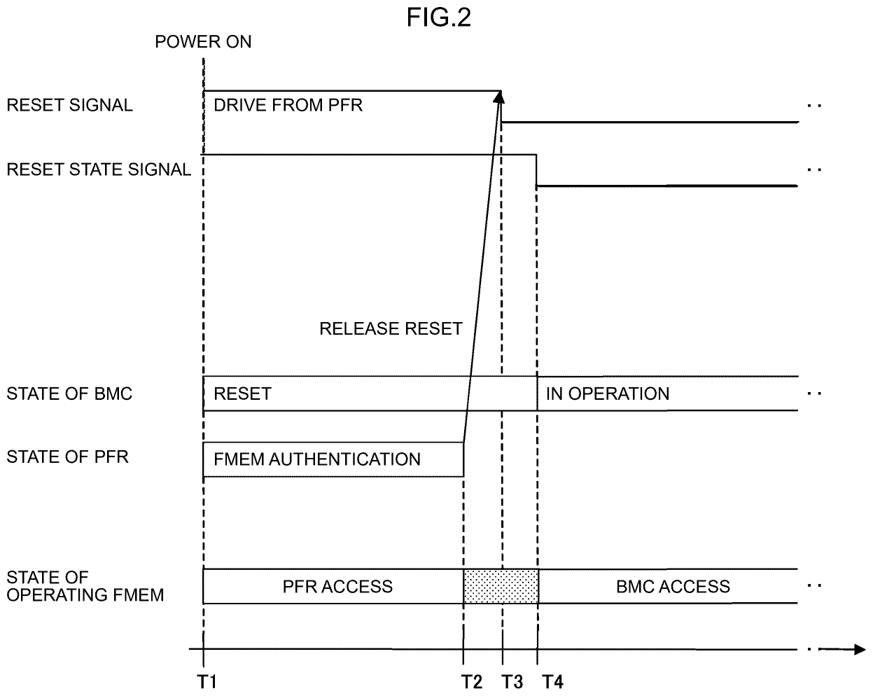

FIG. 2 is a timing chart illustrating a first example of the operation timing of each component of the computer system 1 at power-on of the computer system 1.

When the power is turned on at time T1 and the computer system 1 starts up, the BMC 20 first starts a reset operation for itself. At this time, the PFR 40 outputs a reset signal at high level to the BMC 20 to maintain the reset state of the BMC 20, and starts access to the operating FMEM 30a to read the firmware and authenticate the read firmware.

In the present embodiment, it is assumed that the firmware stored in the operating FMEM 30a contains a digital signature, and the PFR 40 authenticates the firmware by verifying this signature. The authentication of the firmware by the PFR 40 may be performed using other methods.

If the firmware is successfully authenticated, the PFR 40 terminates access to the operating FMEM 30a at time T2. The PFR 40 then changes the signal level of the reset signal from high level to low level at time T3 to release the reset state of the BMC 20. Then, at time T4, the BMC 20 terminates the reset operation, starts a control process, and starts access to the operating FMEM 30a to read and execute the firmware.

If the authentication of the firmware stored in the operating FMEM 30a fails, the PFR 40 restores (copies) the firmware stored as a backup in the standby FMEM 30b into the operating FMEM 30a. The PFR 40 then reads the restored firmware from the operating FMEM 30a, authenticates the firmware, and if the authentication is successful, terminates access to the operating FMEM 30a. The PFR 40 then changes the signal level of the reset signal from high level to low level to release the reset state of the BMC 20. The BMC 20 then terminates the reset operation, starts a control process operation, which is normal operation, and accesses the operating FMEM 30a to read and execute the firmware.

When the control process by the BMC 20 is started as described above, subsequent access to the operating FMEM 30a and the standby FMEM 30b is performed by the BMC 20. However, the PFR 40 may also perform access when the firmware stored in the operating FMEM 30a and the standby FMEM 30b is to be updated. The operation of the PFR 40 in the firmware update operation in the computer system 1 in FIG. 1 will now be described.

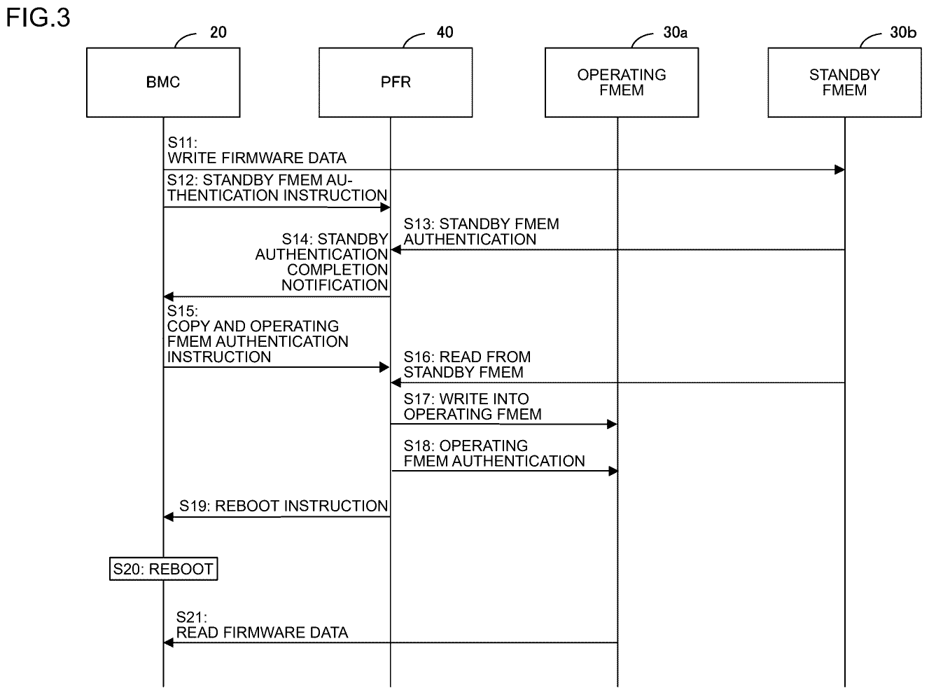

FIG. 3 is a sequence diagram illustrating a flow of a first example of the firmware update operation and represents interactions between the components of the computer system 1 when the firmware to be executed by the BMC 20 is updated.

When the firmware update operation is started, first, the BMC 20 accesses the standby FMEM 30b and writes an updated version of the firmware that the computer system 1 receives from an external device into the standby FMEM 30b (step S11). Next, the BMC 20 stops access to the standby FMEM 30b and instructs the PFR 40 to authenticate the updated version of the firmware written into the standby FMEM 30b (step S12).

Upon receiving the instruction, the PFR 40 accesses the standby FMEM 30b, reads the updated version of the firmware from the standby FMEM 30b, and performs authentication (step S13). When this authentication is completed, the PFR 40 sends an authentication completion notification for the standby FMEM 30b to the BMC 20 to notify the authentication result (success or failure) (step S14).

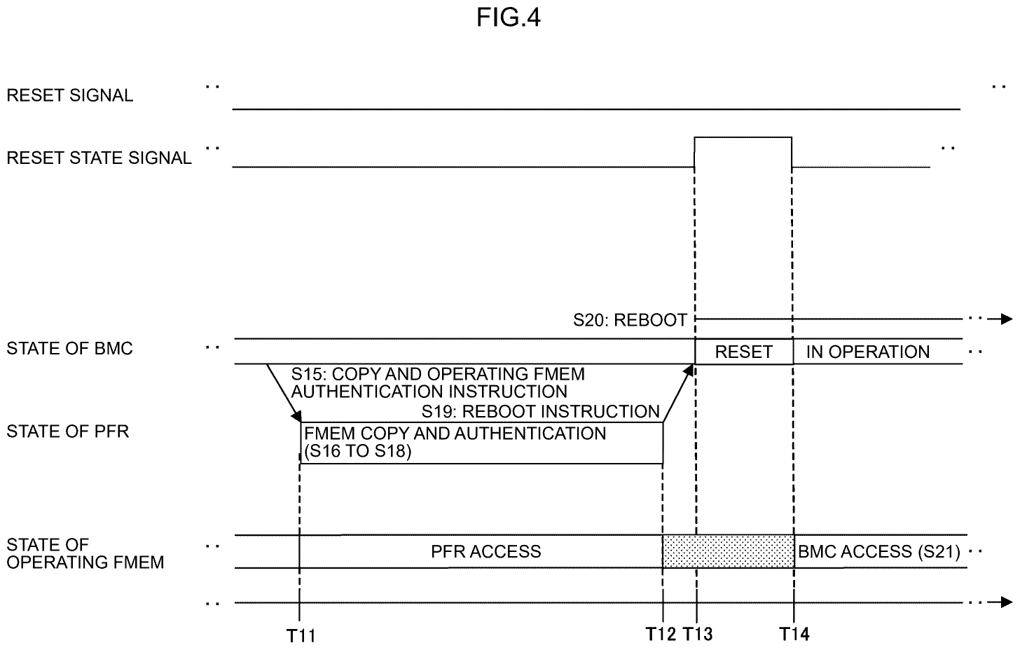

FIG. 4 is a timing chart illustrating a second example of the operation timing of each component of the computer system 1 after the BMC 20 receives the authentication completion notification sent through the operation at step S14 described above. In the following explanation, the sequence diagram in FIG. 3 and the timing chart in FIG. 4 are used together.

When notified of the successful authentication of the updated version of the firmware, the BMC 20 instructs the PFR 40 to copy the updated version of the firmware into the operating FMEM 30a and to authenticate the copied updated version of the firmware (step S15).

Upon receiving the instruction, the PFR 40 starts access to the standby FMEM 30b at time T11 and reads the updated version of the firmware from the standby FMEM 30b (step S16). The PFR 40 then accesses the operating FMEM 30a and copies the read updated version of the firmware by writing it into the operating FMEM 30a (step S17). Furthermore, the PFR 40 reads the copied updated version of the firmware from the operating FMEM 30a and authenticates the read firmware (step S18). Upon completion of this authentication, the PFR 40 terminates access to the standby FMEM 30b at time T12 and, if the authentication is successful, instructs the BMC 20 to reboot (restart) (step S19).

The BMC 20 then starts its reboot at time T13 according to the instruction (step S20), and after the reset operation is completed, starts access to the operating FMEM 30a at time T14 to read the firmware (step S21) and starts execution.

In the computer system 1 illustrated in FIG. 1, the PFR 40 operates as described above so that the integrity of the firmware stored in the operating FMEM 30a and the standby FMEM 30b can be checked.

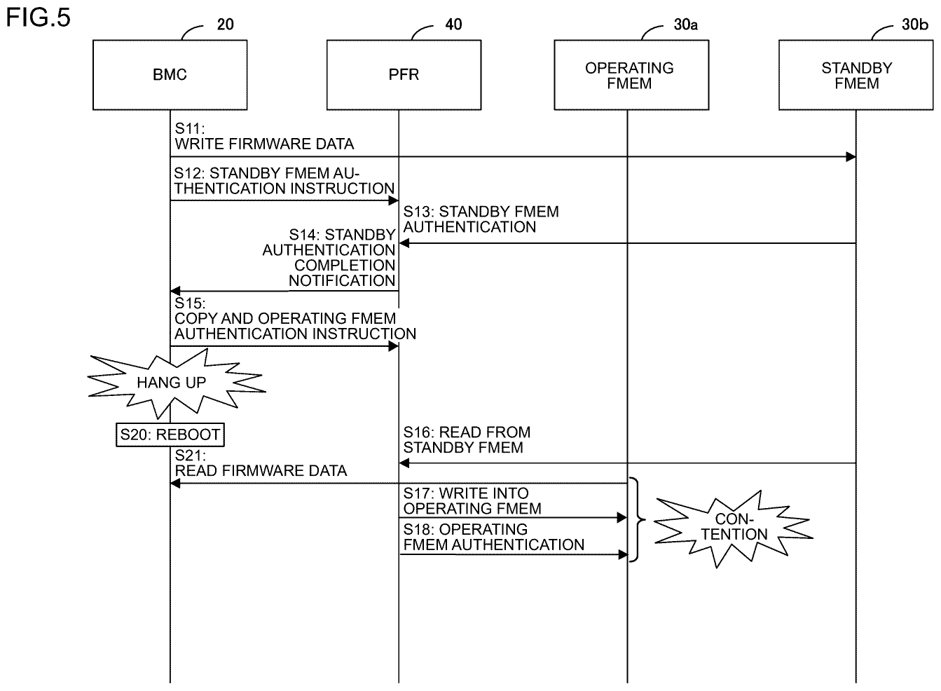

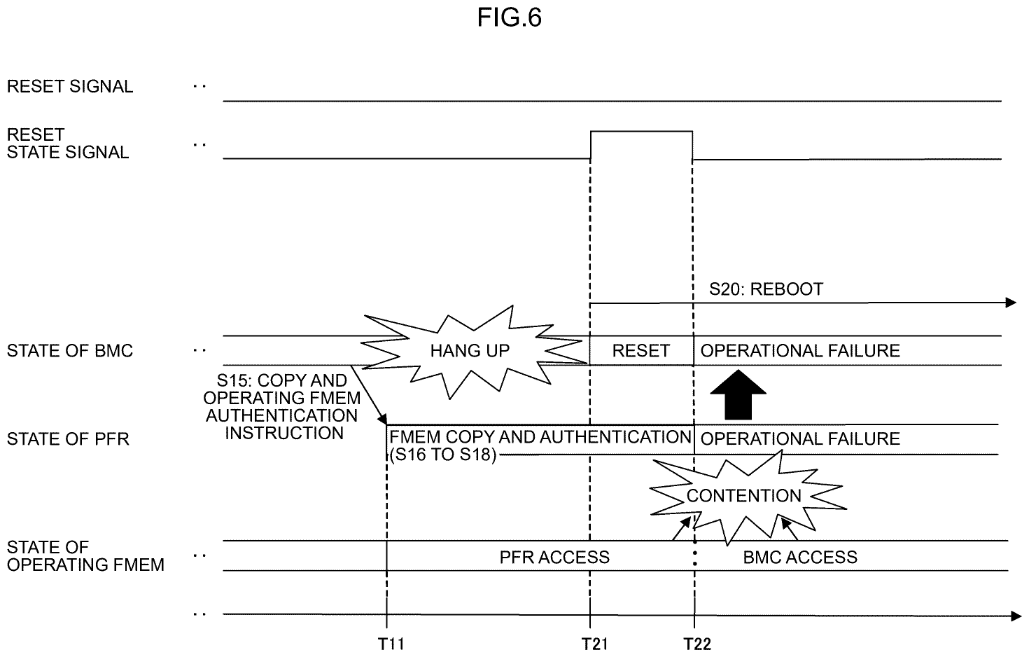

The BMC 20 has a function to monitor its operating state and detect an operation abnormality by a widely known method such as using a watchdog timer. When an operation abnormality is detected, the BMC 20 reboots itself, reads the firmware from the operating FMEM 30a after the reset operation for itself, and starts execution. If such a reboot by the BMC 20 based on its operation abnormality is performed during the firmware update operation described above, contention may occur between the PFR 40 and the BMC 20 over access to the operating FMEM 30a. A specific example of such memory access contention will now be described with reference to FIG. 5 and FIG. 6.

FIG. 5 is a sequence diagram illustrating a flow of a second example of the firmware update operation, and FIG. 6 is a timing chart illustrating a third example of the operation timing of each component of the computer system 1.

The sequence from step S11 to step S15 in FIG. 5 is identical to the sequence in the first example illustrated in FIG. 3, but the second example illustrates a flow of operation when the BMC 20 hangs up after the instruction operation to the PFR 40 at step S15. FIG. 6 represents the operation timing after this instruction operation at step S15.

Upon receiving the instruction at step S15 from the BMC 20, the PFR 40 starts access to the standby FMEM 30b at time T11 and reads the updated version of the firmware from the standby FMEM 30b (step S16). The PFR 40 then accesses the operating FMEM 30a and copies the read updated version of the firmware by writing it into the operating FMEM 30a (step S17). Furthermore, the PFR 40 reads the copied updated version of the firmware from the operating FMEM 30a and authenticates the read firmware (step S18).

The above sequence from step S16 to step S18 is identical to the sequence in the first example illustrated in FIG. 3. However, in the middle of this sequence, the BMC 20 hangs up. Then, the BMC 20 detects its operation abnormality and starts its reboot at time T21 (step S20).

Upon starting its reboot, the BMC 20 first performs a reset operation for itself, and upon completion of the reset operation, starts access to the operating FMEM 30a at time T22 and attempts to read the firmware. At this time, however, access contention occurs because the operating FMEM 30a is accessed by the PFR 40 for copying and authenticating the updated version of the firmware. If contention occurs over access to the operating FMEM 30a, the BMC 20 is unable to read and execute the firmware from the operating FMEM 30a and fails to start itself, resulting in an operational failure. The PFR 40 also fails in the operation of copying and authenticating the updated version of the firmware.

Therefore, in the embodiment described below, detection of the reset operation by the BMC 20 for itself is performed and, when the reset operation is detected, the reset state of the BMC 20 is continued. Further, detection of the completion of the operation of copying and authenticating the updated version of the firmware by the PFR 40 is performed, and when the completion of the operation is detected, the reset state of the BMC 20 that has been continued is released. In this way, a period of the reset state of the BMC 20 is extended until the operation of copying and authenticating the updated version of the firmware by the PFR 40 is completed, so that contention between the BMC 20 and the PFR 40 over access to the operating FMEM 30a is avoided. Thus, an operational failure of the computer system 1 caused by the access contention is prevented.

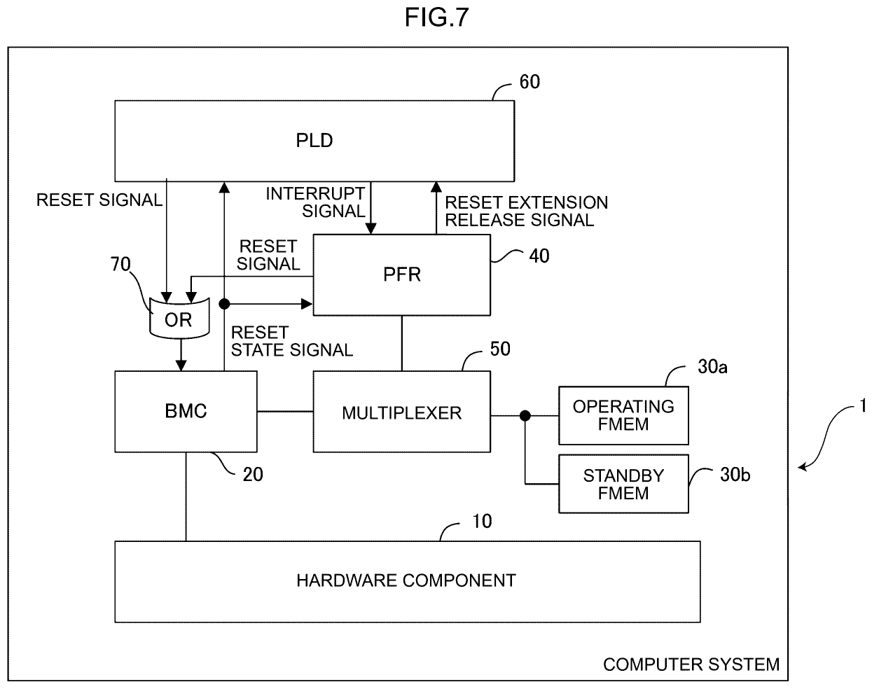

FIG. 7 will now be explained. FIG. 7 illustrates a second example of a configuration of the computer system 1.

The computer system 1 of the second example includes the hardware component 10, the BMC 20, the operating FMEM 30a, the standby FMEM 30b, the PFR 40, and the multiplexer 50, in the same manner as in the first example illustrated in FIG. 1. These components have the same functions as those in the first example illustrated in FIG. 1.

The computer system 1 of the second example further includes a PLD 60 and an OR circuit 70. “PLD” is an abbreviation for programmable logic device, and “OR” is an abbreviation for logical sum.

The PLD 60 is an integrated circuit in which a basic logic circuit, a memory circuit, wiring, a switch, and the like are formed, and a logic configuration to provide a predetermined function can be built by programming. The types of PLD 60 include, for example, programmable array logic (PAL), generic array logic (GAL), complex programmable logic device (CPLD), and field programmable gate array (FPGA), and any of these may be used in the present embodiment.

The OR circuit 70 outputs a signal of the logical sum of two input signals. In the present embodiment, the OR circuit 70 outputs to the BMC 20 a signal of the logical sum of a reset signal driven by the PFR 40 and a reset signal driven by the PLD 60.

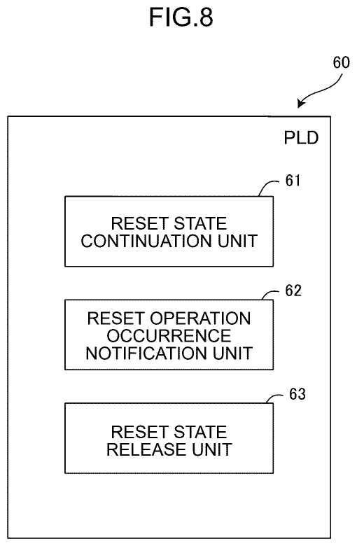

An example of the functional configuration of the PLD 60 will now be described with reference to FIG. 8.

The PLD 60, which functions as a control device in the present embodiment, includes a reset state continuation unit 61, a reset operation occurrence notification unit 62, and a reset state release unit 63.

The reset state continuation unit 61 continues the reset state of the BMC 20, in response to detection of the reset operation by the BMC 20 for itself. The BMC 20, starting the reset operation for itself, outputs a reset state signal as a notification of the start of this reset operation. By detecting this reset state signal, the PLD 60 detects the reset operation by the BMC 20 for itself.

In response to detection of the reset operation, the PLD 60 outputs a reset signal with a signal level of high level to the BMC 20 via the OR circuit 70, thereby continuing the reset state of the BMC 20. The reset signal driven by the PLD 60 is also a signal with two different signal levels, that is, a signal with a signal level of either high level or low level. The BMC 20 maintains its reset state while the reset signal received from the OR circuit 70 is at high level.

The reset operation occurrence notification unit 62 sends a notification of occurrence of the reset operation in the BMC 20 to the PFR 40. The PLD 60 sends a notification of occurrence of the reset operation to the PFR 40 by outputting an interrupt signal to the PFR 40.

The reset state release unit 63 releases the reset state that is being continued in the BMC 20, in response to detection of the completion of the operation of writing the updated version of the firmware into the operating FMEM 30a by the PFR 40. Upon completion of the operation of writing the updated version of the firmware into the operating FMEM 30a, the PFR 40 outputs a reset extension release signal to the PLD 60 as a notification of the completion of the writing operation. By detecting this reset extension release signal, the PLD 60 detects the completion of the operation of writing the updated version of the firmware into the operating FMEM 30a by the PFR 40. In response to detection of the completion of the writing operation, the PLD 60 changes the signal level of the reset signal output to the BMC 20 via the OR circuit 70 from high level to low level to release the reset state of the BMC 20.

In the present embodiment, it is assumed that the operation of writing the updated version of the firmware into the operating FMEM 30a by the PFR 40 includes an authentication operation for the updated version of the firmware written into the operating FMEM 30a. Thus, the PLD 60 releases the reset state that is being continued in the BMC 20, in response to detection of the completion of the authentication operation for the updated version of the firmware written into the operating FMEM 30a.

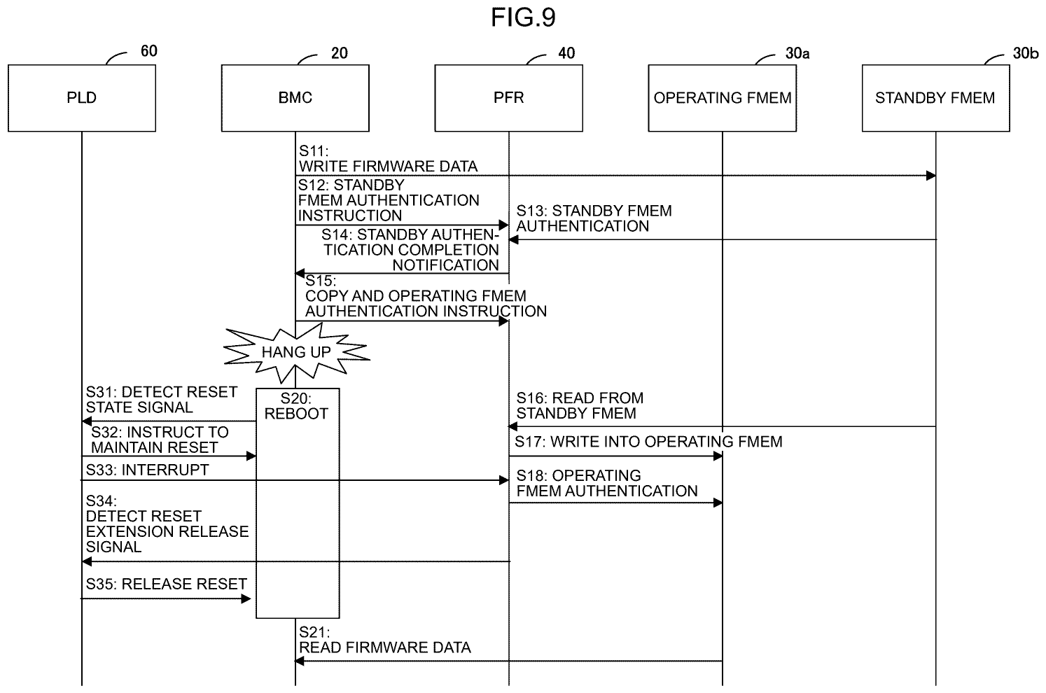

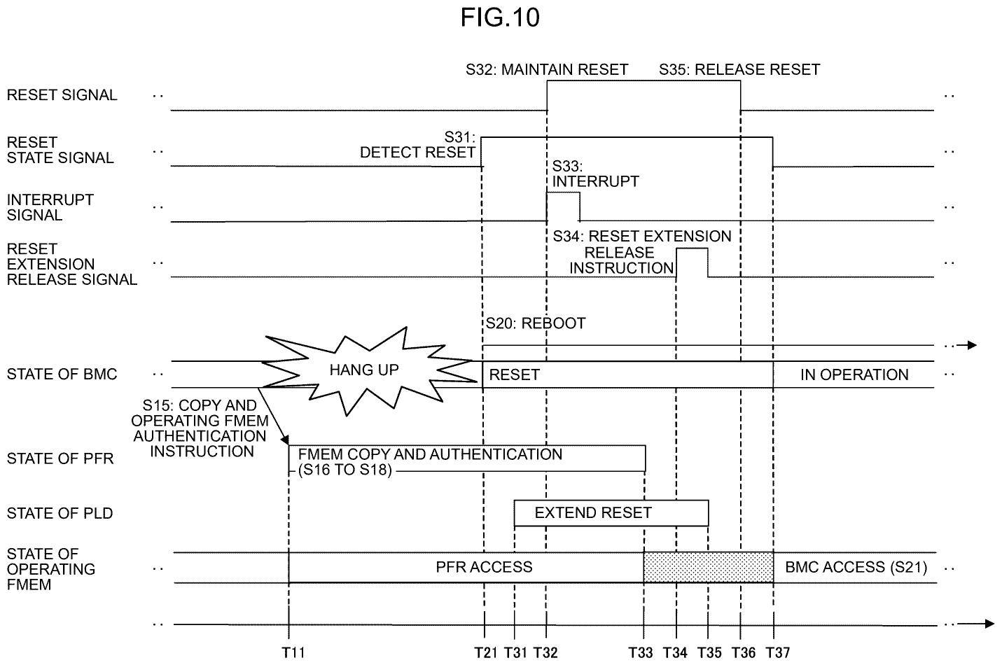

Next, in the computer system 1 of the second example illustrated in FIG. 7, the access to the operating FMEM 30a by the PFR 40 and the BMC 20 when the BMC 20 is rebooted during the firmware update operation will be described with reference to FIG. 9 and FIG. 10.

FIG. 9 is a sequence diagram illustrating a flow of a third example of the firmware update operation, and FIG. 10 is a timing chart illustrating a fourth example of the operation timing of each component of the computer system 1.

The sequence from step S11 to step S15 in FIG. 9 is identical to the sequence in the second example illustrated in FIG. 5. Furthermore, the sequence in FIG. 9 illustrates a flow of operation in a case where the BMC 20 hangs up after the instruction operation to the PFR 40 at step S15, in the same manner as in the second example illustrated in FIG. 5. FIG. 10 represents the operation timing after this instruction operation at step S15.

When notified of the successful authentication of the updated version of the firmware, the BMC 20 instructs the PFR 40 to copy the updated version of the firmware into the operating FMEM 30a and to authenticate the copied updated version of the firmware (step S15). Upon receiving the instruction from the BMC 20, the PFR 40 starts access to the standby FMEM 30b at time T11 and reads the updated version of the firmware from the standby FMEM 30b (step S16). The PFR 40 then accesses the operating FMEM 30a and copies the read updated version of the firmware by writing it into the operating FMEM 30a (step S17). Furthermore, the PFR 40 reads the copied updated version of the firmware from the operating FMEM 30a and authenticates the read firmware (step S18). However, in the middle of the above sequence from step S16 to step S18, the BMC 20 hangs up. Then, the BMC 20 detects its operation abnormality and starts its reboot at time T21 (step S20). The sequence up to this point is identical to the sequence in the second example illustrated in FIG. 5.

Upon starting its reboot at time T21, the BMC 20 performs a reset operation for itself and outputs a reset state signal as a notification of the start of the reset operation. The PLD 60 performs a process of detecting the reset state signal (step S31) and, upon detecting the signal, starts a reset extension process.

Upon starting the reset extension process, the PLD 60 first sets the signal level of the reset signal output to the BMC 20 via the OR circuit 70 to high level at time T31 and performs a process of continuing the reset state of the BMC 20 (step S32). While the signal level of this reset signal is high level, the BMC 20 continues the reset state, so that access from the BMC 20 to the operating FMEM 30a to read the updated version of the firmware is not performed.

Then, at time T32, the PLD 60 performs a process of outputting an interrupt signal to the PFR 40 to notify the PFR 40 of the occurrence of the reset operation by the BMC 20 for itself (step S33). The PFR 40, receiving this interrupt signal, starts an interrupt process.

Thereafter, the operation of writing the updated version of the firmware into the operating FMEM 30a, including the authentication operation for the updated version of the firmware, by the PFR 40 according to the sequence from step S16 to step S18 described above, is completed at time T33. Then, at the following time T34, the PFR 40 performs, as the interrupt process, a process of outputting a reset extension release signal to the PLD 60 as a notification of the completion of the writing operation.

The PLD 60 performs a process of detecting the reset extension release signal output from the PFR 40 (step S34). Upon detecting the reset extension release signal through this process, the PLD 60 terminates the reset extension process at time T35. Then, at the following time T36, the PLD 60 performs a process of releasing the reset state that is being continued in the BMC 20 by changing the signal level of the reset signal from high level to low level (step S35).

When the signal level of the reset signal sent from the PLD 60 changes to low level, the BMC 20 terminates the reset operation at time T37, starts access to the operating FMEM 30a to read the firmware (step S21), and starts execution.

As described above, in the second example of the computer system 1 illustrated in FIG. 7, the operation of reading the firmware from the operating FMEM 30a by the BMC 20 is started after the completion of the operation of writing the firmware into the operating FMEM 30a by the PFR 40. Thus, contention over access to the operating FMEM 30a by the PFR 40 and the BMC 20 is avoided, and the occurrence of an operational failure in the computer system 1 due to such access contention is prevented.

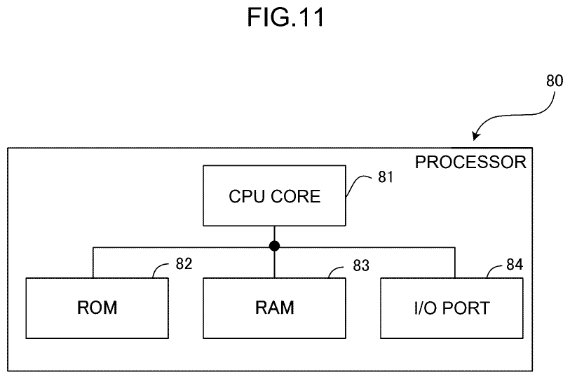

The computer system 1 may be configured by replacing the PLD 60 in the configuration illustrated in FIG. 7 with a processor 80 having a hardware configuration as illustrated in FIG. 11.

In the configuration example illustrated in FIG. 11, the processor 80 includes a CPU core 81, a ROM 82, a RAM 83, and an I/O port 84. “ROM” is an abbreviation for read only memory, “RAM” is an abbreviation for random access memory, and “I/O port” is an abbreviation for input/output port.

In the processor 80, the CPU core 81 controls the I/O port 84 by executing a computer program stored in the ROM 82 using the RAM 83 to acquire a signal sent from a device connected to the I/O port 84 and output a signal to the device.

When the computer system 1 is configured using this processor 80, a control program is prepared in advance to allow the processor 80 to perform the process from step S31 to step S35 performed by the PLD 60, as explained with reference to FIG. 9. The prepared control program is stored in the ROM 82. The I/O port 84 is connected to each component to allow acquisition of the reset state signal output from the BMC 20 and the reset extension release signal output from the PFR 40, and output of the interrupt signal to the PFR 40 and the reset signal to the OR circuit 70. Then, when the processor 80 starts up, the control program stored in the ROM 82 is read and executed by the CPU core 81, so that the processor 80 can perform a control method performed by the PLD 60.

In one aspect, the present invention can avoid memory access contention.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is

1. A non-transitory computer-readable recording medium having stored therein a control program that causes a processor to execute a process comprising:
continuing a state of reset of a controller, in response to detection of an operation of the reset by the controller for the controller itself, the controller performing a process of controlling hardware by executing firmware stored in a first memory; and
releasing the state of the reset in response to detection of completion of an operation of writing an updated version of the firmware into the first memory by a management unit that manages the firmware.

2. The non-transitory computer-readable recording medium according to claim 1, wherein
the control program further causes the processor to perform a process of sending a notification of occurrence of the operation of reset to the management unit in response to detection of the operation of reset, and
the process of releasing the state of the reset is performed in response to detection of a completion notification output when the operation of writing into the first memory is completed, from the management unit receiving the notification of the occurrence.

3. The non-transitory computer-readable recording medium according to claim 1, wherein
the controller performs an operation of writing the updated version of the firmware into a second memory and also performs the operation of reset in response to detection of an operation abnormality of the controller itself after the operation of writing into the second memory,
the management unit reads the updated version of the firmware from the second memory and starts an operation of writing the updated version of the firmware into the first memory, in response to a predetermined instruction output from the controller when the operation of writing the updated version of the firmware into the second memory is completed, and
the process of releasing the state of the reset is performed in response to detection of a completion notification output from the management unit when the operation of writing the updated version of the firmware into the first memory is completed.

4. The non-transitory computer-readable recording medium according to claim 1, wherein the process of continuing the state of the reset is performed in response to detection of a start notification output from the controller when the operation of reset is started.

5. The non-transitory computer-readable recording medium according to claim 1, wherein
the process of continuing the state of the reset is a process of outputting a predetermined signal to the controller, and
the process of releasing the state of the reset is a process of changing the predetermined signal to a different signal.

6. The non-transitory computer-readable recording medium according to claim 1, wherein
the operation of writing includes an authentication operation for the updated version of the firmware written into the first memory, and
the process of releasing the state of the reset is performed in response to detection of completion of the authentication operation.

7. A control method performed by a processor, the control method comprising:
continuing a state of reset of a controller, in response to detection of an operation of the reset by the controller for the controller itself, the controller performing a process of controlling hardware by executing firmware stored in a first memory; and
releasing the state of the reset in response to detection of completion of an operation of writing an updated version of the firmware into the first memory by a management unit that manages the firmware.

8. A control device comprising:
a reset state continuation unit that, continues a state of the reset of the controller, in response to detection of an operation of the reset by the controller for the controller itself, the controller performing a process of controlling hardware by executing firmware stored in a first memory; and
a reset state release unit that releases the state of the reset in response to detection of completion of an operation of writing an updated version of the firmware into the first memory by a management unit that manages the firmware.
